(19) United States
(12) Patent Application Publication
(10) Pub. No.: US 2006/0095305 A1
(43) Pub. Date: May 4, 2006

(54) Insurance coverage verification

(75) Inventors: Bill Madison, Alpharetta, GA (US); Jeanne Trocheck, Roswell, GA (US)

Correspondence Address: KING & SPALDING LLP, 191 PEACHTREE STREET, N.E., 45TH FLOOR, ATLANTA, GA, 30303-1763, US

(73) Assignee: ChoicePoint, Asset Company, Wilmington, DE (US)

(21) Appl. No.: 11/261,347

(22) Filed: Oct. 28, 2005

Related U.S. Application Data
(60) Provisional application No. 60/623,596, filed on Oct. 29, 2004.
(60) Provisional application No. 60/657,278, filed on Mar. 1, 2005.

(51) Int. Cl. G06Q 40/00

(52) U.S. Cl. 705/4

(57) ABSTRACT

Automated generation of reports based on insurance coverage of youthful drivers. Insurance carriers can automatically obtain, at appropriate times, customized reports for use in monitoring insurance coverage of youthful drivers. The youthful drivers can be newly-licensed persons who reside with insured persons. The reports can indicate whether the youthful drivers are insured by a particular insurance carrier and/or whether they are uninsured persons. The insurance carriers can designate the reports' format, content, generation times, and output times. In designating the output times, the insurance carriers can designate whether and/or when to delay output of certain generated reports. In addition, the insurance carriers can designate whether and/or when to update and/or verify the contents of each generated report prior to outputting the report. Allowing insurance carriers to designate when, how, and in what format, they wish to receive the reports permits for more effective, more efficient, continuous monitoring of youthful drivers.

### RELATED PATENT APPLICATIONS

This patent application claims priority under 35 U.S.C. § 119 to U.S. Provisional Patent Application No. 60/623,596, entitled “Method and System for Insurance Coverage Verification,” filed Oct. 29, 2004, and U.S. Provisional Patent Application No. 60/657,278, entitled “Method and System for Evaluating Risk of Insuring an Individual Based on Timely Assessment of Motor Vehicle Records,” filed Mar. 1, 2005. The complete disclosure of the above-identified applications is hereby fully incorporated herein by reference.

### FIELD OF THE INVENTION

The invention relates generally to monitoring youthful drivers and more particularly to the automated generation and output, at appropriate times, of customized reports based on the insurance coverage of youthful drivers.

### BACKGROUND OF THE INVENTION

Commonly referred to as “Generation Y,” the group of Americans born between 1979 and 1994 represents approximately 28% of the United States population. Generation Y is the largest consumer group in the history of the United States. In fact, Generation Y buyers age 16 to 24 currently are the largest-growing consumer segment. According to certain market research, Generation Y buyers age 16 to 24 will purchase two million vehicles in 2006 and ten million vehicles in 2010.

Each year, Generation Y gains at least 40,000 licensed drivers. Those newly-licensed youthful drivers represent a considerable market for both vehicles and auto insurance. Timely identification of such youthful drivers can help insurance carriers to more successfully market their services. For example, the insurance carriers can target advertisements to the youthful drivers. The advertisements can inform the youthful drivers both of the legal need for auto insurance and the advantages of the particular insurance carrier's services.

In addition, timely identification of youthful drivers can help insurance carriers to obtain higher insurance premiums from existing customers. For example, in certain circumstances, if an uninsured youthful driver resides with an existing auto insurance customer, the insurance carrier can raise the customer's insurance premium upon identifying the youthful driver. The higher premium can account for the insurance carrier's coverage of the identified youthful driver.

Conventionally, insurance carriers have attempted to identify youthful drivers by manually searching and analyzing a variety of public records. Generally, such manual searches are performed on a state-by-state and person-by-person basis, consuming much of the insurance carriers' time, money, and other resources.

After manually obtaining the records, the insurance carriers must analyze each record to identify the youthful drivers. For each identified youthful driver, the insurance carriers must also determine: (1) whether and/or when to advertise to the identified youthful driver; (2) whether the identified youthful driver already has insurance; (3) whether the identified youthful driver resides with an existing customer; and/or (4) whether and/or when to raise the existing customer's insurance premium to account for coverage of the identified youthful driver.

For example, an insurance carrier may wish to advertise only to youthful drivers who are not already insured. In addition, the insurance carriers may wish to advertise to uninsured youthful drivers and/or raise existing customers' premiums only after a designated grace period. For example, the insurance carriers may desire to provide each identified uninsured youthful driver with a period in which to obtain his or her own insurance coverage without solicitation.

In the conventional art, insurance carriers are unable to determine whether identified youthful drivers are uninsured. Though each insurance carrier generally is able to determine whether the identified youthful drivers are covered by the insurance carrier's particular brand of insurance, the insurance carriers conventionally have been unable to verify whether the identified youthful drivers are insured by other insurance carriers. Without making such a verification, the insurance carriers cannot base any of their advertising or pricing decisions on the insurance coverage of the identified youthful drivers.

In view of the foregoing, a need exists in the art for a system and method for efficiently identifying youthful drivers. In addition, a need exists in the art for a system and method for efficiently monitoring the insurance coverage of identified youthful drivers. A further need exists in the art for such systems and methods to output the information obtained in so identifying and monitoring the youthful drivers in a desirable format that accounts for insurance carrier-specific guidelines for which information should be considered at which times.

### SUMMARY OF THE INVENTION

The invention provides systems and methods for monitoring youthful drivers. Specifically, the invention provides systems and methods for automatically generating and outputting, at appropriate times, customized reports based on the insurance coverage of youthful drivers. For example, insurance carriers can use the customized reports to monitor insured persons' households for newly-licensed youthful drivers. The customized reports can indicate whether each newly-licensed youthful driver is an uninsured person. According to pre-set designations of each insurance carrier, the customized reports can comprise information regarding the youthful drivers, the insured persons, and/or the insured persons' insurance policies.

The term “insurance carrier” is used herein to refer to a provider of automobile insurance. In addition to the automobile insurance, an insurance carrier can also provide another type or types of insurance, such as property insurance. The term “insured person” is used herein to refer to any person insured by at least one insurance carrier. The term “youthful driver” is used herein to refer to any licensed or permitted driver age 25 or younger. The terms “uninsured youthful driver” and “uninsured person” are used interchangeably herein to refer to any licensed or permitted driver who is potentially not a party to an auto insurance policy.

Discovering the existence and identity of uninsured youthful drivers allows insurance carriers to target advertisements to the newly-discovered uninsured persons. The advertisements can inform the newly-discovered uninsured persons both of the legal need for auto insurance and the advantages of the particular insurance carrier's services. In addition, discovery of uninsured youthful drivers may allow insurance carriers to raise existing customers' insurance premiums. In certain circumstances, where an uninsured youthful driver resides with an existing auto insurance customer, the insurance carrier can raise the customer's premium to account for its coverage of the youthful driver.

In one aspect of the invention, a coverage verification module can determine a youthful driver's insurance coverage by utilizing multiple insurance carriers' policy data and insured data. The insurance carriers can comprise a first insurance carrier and at least one other insurance carrier. For each insurance carrier, the policy data can comprise information regarding at least one auto insurance policy of the insurance carrier. For each such auto insurance policy, the insured data can comprise information regarding at least one insured person insured on the auto insurance policy.

For example, the youthful driver can reside with an insured person. The insured person can be insured on an insurance policy of any of the insurance carriers. The coverage verification module can identify the youthful driver residing with the insured person.

An agent or agents of the insurance carriers can create youthful driver data comprising information regarding the youthful driver. For example, the youthful driver data can comprise a name of the youthful driver, an address of the youthful driver, a driver's license issue date of the youthful driver, and/or a date of birth of the youthful driver.

The term “agent” is used herein to refer to any person or entity operating on behalf of an insurance carrier or authorized to take any action on behalf of an insurance carrier.

Based on the youthful driver data, policy data, and/or the insured data, the coverage verification module can determine whether the youthful driver is insured by the first insurance carrier and/or whether the youthful driver is an uninsured person. For example, the coverage verification module can determine whether the youthful driver is insured by the first insurance carrier by comparing the youthful driver data to the first insurance carrier's policy data and/or insured data.

If the coverage verification module determines that the youthful driver is not insured by the first insurance carrier, the coverage verification module can determine whether the youthful driver is an uninsured person by determining whether the youthful driver is insured on an auto insurance policy of any of the insurance carrier(s). For example, the coverage verification module can make such a determination by comparing the youthful driver data to the insurance carriers' policy data and/or insured data. If the coverage verification module determines that the youthful driver is not insured on an auto insurance policy of any of the insurance carrier(s), then the coverage verification module will determine that the youthful driver is an uninsured person.

The coverage verification module can generate a report comprising information regarding: (1) whether the youthful driver is insured on an auto insurance policy of the first insurance carrier; and/or (2) whether the youthful driver is an uninsured person (i.e., whether the youthful driver is not insured on an auto insurance policy of any of the insurance carrier(s)). For example, the coverage verification module can apply rule data designating the format of the report and/or the content of the report to the policy data, insured data, and/or youthful driver data to generate the report. A report recipient, such as the first insurance carrier, can create at least a portion of the rule data.

In another aspect of the invention, the coverage verification module can determine whether the youthful driver is insured on an auto insurance policy of the first insurance carrier on a first day and can determine whether the youthful driver is an uninsured driver (i.e., whether the youthful driver is insured on an auto insurance policy of any of the insurance carrier(s)) on a second day. Waiting until a second day to determine whether the youthful driver is an uninsured driver allows the youthful driver a grace period during which to obtain his or her own insurance coverage. Until the second day, no report regarding the youthful driver's uninsured status will be generated or outputted. Thus, until at least the second day, the youthful driver will be free to obtain insurance coverage without solicitation. In addition, until at least the second day, the insurance premium(s) of any insured person(s) living with the youthful driver will not be raised.

These and other aspects, objects, features, and advantages of the invention will become apparent to a person skilled in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for generating and outputting at appropriate times customized reports based on the insurance coverage of youthful drivers, according to an exemplary embodiment of the invention.

FIG. 2 is a block diagram depicting a control module of a system for generating and outputting at appropriate times customized reports based on the insurance coverage of youthful drivers, according to an exemplary embodiment of the invention.

FIG. 3 is a flow chart depicting a method for generating and outputting at appropriate times customized coverage verification reports, according to an exemplary embodiment of the invention.

FIG. 4 is a flow chart depicting a method for generating a coverage verification report, according to an exemplary embodiment of the invention.

FIG. 5 is a flow chart depicting a method for determining whether an identified youthful driver is an uninsured youthful driver.

FIG. 6 is a flow chart depicting a method for generating and outputting at appropriate times customized coverage verification reports, according to an exemplary embodiment of the invention.

FIG. 7 is a block diagram depicting a coverage verification report generated in accordance with an exemplary embodiment of the invention.

FIG. 8 is a block diagram depicting a coverage verification report generated in accordance with an alternative exemplary embodiment of the invention.

### DETAILED DESCRIPTION OF EXEMPLARY EMBODIMENTS

The invention is directed to automated generation and output, at appropriate times, of customized reports regarding the insurance coverage of youthful drivers. Discovering the existence and identity of uninsured youthful drivers allows insurance carriers to target advertisements to the newly-discovered uninsured persons. The advertisements can inform the newly-discovered uninsured persons both of the legal need for auto insurance and the advantages of the particular insurance carrier's services.

Discovery of uninsured youthful drivers also may allow insurance carriers to raise existing customers' insurance premiums. In certain circumstances, where an uninsured youthful driver resides with an existing auto insurance customer, the insurance carrier can raise the customer's premium to account for its coverage of the youthful driver.

In accordance with an exemplary embodiment of the invention, insurance carriers can automatically obtain, at appropriate times, customized reports for use in monitoring the insurance coverage of youthful drivers. In particular, the insurance carriers can use the customized reports to monitor insured persons' households for newly-licensed youthful drivers. For example, the customized reports can indicate whether each newly-licensed youthful driver is an uninsured person. According to pre-set designations of each insurance carrier, the customized reports can comprise information regarding the youthful drivers, the insured persons, and/or the insured persons' insurance policies.

For example, the insurance carriers can designate the reports' format, content, generation times, and output times. Allowing insurance carriers to designate when, how, and in what format, they wish to receive the reports permits for more effective, more efficient, continuous monitoring of youthful drivers.

The term “report” is used herein to refer to any data and/or output created in accordance with an exemplary embodiment of the present invention. For example, a report can comprise comprehensive information regarding a youthful driver. Alternatively, the report can comprise an acknowledgment that the system failed to find any pertinent information.

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

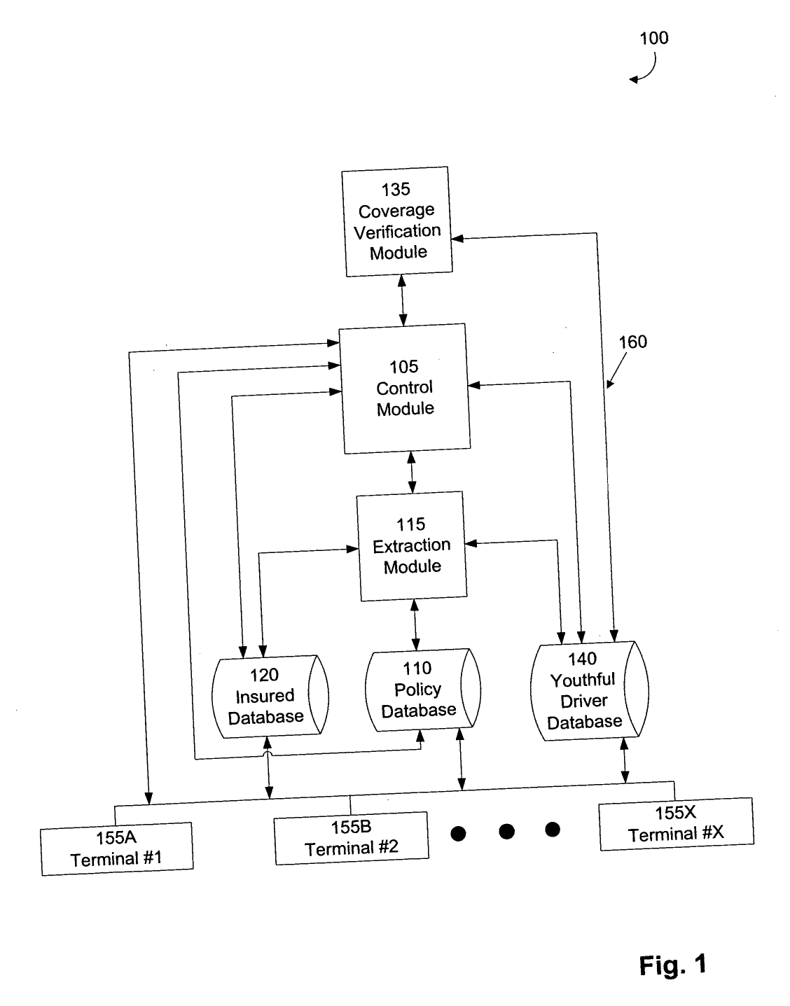

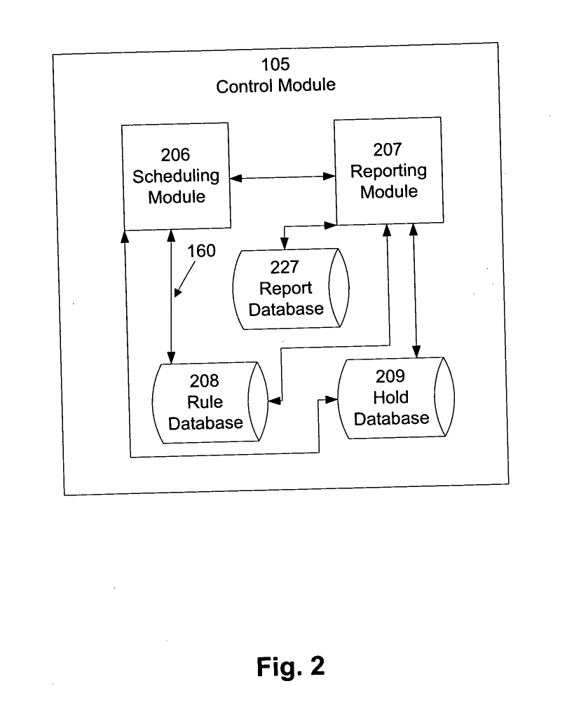

An exemplary system for generating and outputting at appropriate times customized reports based on the insurance coverage of youthful drivers will now be described with reference to FIGS. 1-2. FIG. 1 is a block diagram depicting a system 100 for generating and outputting at appropriate times customized reports based on the insurance coverage of youthful drivers, according to an exemplary embodiment of the invention. FIG. 2 is a block diagram depicting a control module 105 of the system 100, according to an exemplary embodiment of the invention. A person skilled in the art will appreciate that FIGS. 1-2 and the associated discussion are intended to provide a general description of representative computer devices and program modules for implementing the exemplary embodiment.

The exemplary system 100 comprises an arrangement of computer-based components coupled to one another through a set of data links 160 such as a network 160. While some of the system's functions are implemented in a single system component, other functions are dispersed among components. The information structure of the system 100 offers a distributed computing environment. In this environment, the code behind the software-based process steps does not necessarily execute in a singular component; rather, the code can execute in multiple components of the system 100.

The system's communication network 160, a set of data links 160, facilitates information flow between the components. For a system 100 in which all components are located at the same site, a local area network can provide the backbone for the system's communication network 160. In a system 100 with geographically dispersed components, the communications network 160 can comprise a wide area network, a virtual network, a satellite communications network, or other communications network elements as are known in the art.

In an exemplary application of the system 100, at least one insurance carrier's policy data is stored in a policy database 110. The policy data comprises each insurance carrier's insurance policy information, such as: (1) the insurance carrier's A.M. Best number (a carrier-specific numerical identifier); (2) the insurance carrier's National Association of Insurance Commissioners (NAIC) number (a carrier-specific numerical identifier); (3) a PIN number for each person insured by the insurance carrier; (4) a designation, for each policy, of which insured person is the primary policyholder; (5) the type of insurance (e.g., auto or property) provided for under each insurance policy; (6) each insurance policy's policy type, including, e.g., whether the insurance policy is for full (comprehensive) coverage, collision, bodily injury, property damage, catastrophe damage, and/or liability, and the amounts and types of reimbursement provided for under the policy; (7) each insurance policy's insurance inception date; (8) each insurance policy's most recent policy period begin date; (9) each insurance policy's policy period end date; (10) the vehicle identification number of each vehicle, if any, insured on each policy; and/or (11) the vehicle make, model, and model year for each vehicle, if any, insured on each insurance policy.

In one embodiment of the invention, the insurance carrier(s) and/or an agent or agents of the insurance carrier(s) can store the policy data in the policy database 110. For example, the insurance carrier(s) and/or agent(s) can access the policy database 110 via a terminal 155. The terminal 155 can be any device through which data or information can be entered or displayed.

The term “agent” is used herein to refer to any person or entity operating on behalf of an insurance carrier or authorized to take any action on behalf of an insurance carrier.

Similarly, insured data of the insurance carrier(s) is stored in an insured database 120. The insured data comprises information regarding persons insured by the insurance carrier(s). For example, the insured data can comprise: (1) the name of each insured person; (2) the address of each insured person; (3) the date of birth of each insured person; (4) one or more PIN numbers for each insured person; (5) the social security number of each insured person; (6) the A.M. Best number of each insurance carrier that provides insurance to each insured person; (7) the driver's license number of each (licensed) insured person; and/or (8) the driver's license state of each (licensed) insured person.

In one embodiment of the invention, the insurance carrier(s) and/or an agent or agents of the insurance carrier(s) can store the insured data in the insured database 120. For example, the insurance carrier(s) and/or agent(s) can access the insured database 120 via the terminal 155.

Rule data of the insurance carrier(s) is stored in a rule database 208 of a control module 105. The rule data comprises each insurance carrier's preferences, and internal rules, for the operation of an exemplary embodiment of the invention. For example, the insurance carrier preferences can include: (1) which type(s) of report(s) to generate; (2) for which insured person(s) and/or insurance policy(ies) to generate the report(s); (3) what information to include in each report; (4) the format of each report; (5) when to generate each report; (6) how long, if at all, to store each report in a data storage medium; and/or (7) when to output each report, including, e.g., whether to delay outputting certain generated reports until a later “hold date” and/or how to determine the hold date. Each report for which output is delayed is referred to herein as a “hold report.”

If the rule data indicates an insurance carrier's preference to delay outputting certain generated reports until a later hold date, the rule data can further comprise whether to update the contents of each hold report and/or verify the contents of each hold report on or before the hold date. In addition, the rule data can comprise the insurance carrier's preference for the date or dates on which to update and/or verify the hold report contents.

The terms “date” and “time” are used interchangeably herein to refer generically to any date, time, or date and time.

In one embodiment of the invention, the insurance carrier preferences can depend on information retrieved by the system 100 in generating the report(s). For example, the insurance carrier can designate specific formatting and content preferences that depend on whether the system 100 identifies any uninsured youthful drivers. If the system 100 identifies at least one uninsured youthful driver, for example, the insurance carrier may desire an immediately-outputted, detailed report. Alternatively, if the system 100 fails to identify any uninsured youthful drivers, the insurance carrier may desire to delay output of a succinct report or may even prefer not to receive any report. In one embodiment of the invention, unless and until insurance carrier preferences are stored in the rule database 208, the rule data can comprise pre-set standard designations.

For example, the internal rules for the operation of an exemplary embodiment of the invention can comprise: (1) rules defining how each component of the system 100 interacts, including, e.g., the type, amount, and form of data to transfer from one component of the system 100 to another component of the system 100 for the system 100 to function properly; (2) rules defining how to obtain youthful driver data; and/or (3) rules defining, for each youthful driver data source, the type and form of data required to obtain the youthful driver data.

In one embodiment of the invention, the agent(s) of the insurance carrier(s) can store the rule data in the rule database 208. For example, the agent(s) can access the rule database 208 via the terminal 155.

The term “youthful driver data” is used herein to refer to information regarding one or more youthful drivers. For example, the youthful driver data can comprise: (1) the name, address, and/or date of birth of each youthful driver; (2) the social security number of each youthful driver; (3) the gender of each youthful driver; (4) the driver's license number of each youthful driver; (5) the driver's license state of each youthful driver; (6) the driver's license issue date for each youthful driver; (7) the driver's license expiration date for each youthful driver; (8) the driver's license status (i.e., whether the license is a full license or a permit) for each youthful driver; (9) the driver's license class for each youthful driver; and/or (10) a list of restriction indicators, if any, on each youthful driver's license. For privacy purposes, certain of the youthful driver data, such as the social security number(s), can be truncated. For example, a youthful driver data source can be a state motor vehicle department or a student listing, such as the American Student Listing.

The youthful driver data is stored in a youthful driver database 140. In one embodiment of the invention, the agent(s) of the insurance carrier(s) can store the youthful driver data in the youthful driver database 140. For example, the agent(s) can access the youthful driver database 140 via the terminal 155.

Storage of the policy data, the insured data, the rule data, and the youthful driver data in the policy database 110, the insured database 120, the rule database 208, and the youthful driver database 140, respectively, enables system components to utilize available information about an insurance carrier's preferences, insurance policies, and insured persons to automatically and continuously generate and output at appropriate times customized reports based on the insurance coverage of youthful drivers.

One exemplary application of the system 100 comprises an extraction module 115 that interacts with the policy database 110, the insured database 120, the rule database 208, and/or the youthful driver database 140 to translate certain stored data into hold data comprising a hold date. Depending on the particular application of the system 100, the rule data for a particular insurance carrier can comprise an insurance carrier's specifically designated hold date. In other words, when submitting preferences (in the form of rule data), the insurance carrier can designate a static date (e.g., December 14^{th}, 2004) to be the hold date. In that case, to obtain the hold date, the extraction module 115 simply extracts the hold date from the rule data.

Alternatively, the rule data for a particular insurance carrier can comprise a method for calculating the hold date. The method can utilize the rule data, policy data, insured data, and/or youthful driver data. For example, the insurance carrier can designate that the hold date is based on the license issue date of a youthful driver. For example, the hold date can be X (a designated number) number of days after the license issue date.

The extraction module 115 stores the hold data in a hold database 209 of the control module 105.

In addition to the rule database 208 and the hold database 209, the control module 105 comprises a scheduling module 206, a reporting module 207, and a report database 227. The scheduling module 206 signals the reporting module 207 to generate and output reports at designated times. For example, the times can be designated in the rule data. Integration with the other system components, including without limitation the insured database 120, the policy database 110, the rule database 208, and the youthful driver database 140, enables the scheduling module 206 to ensure that it signals the reporting module 207 for action at appropriate times.

In one embodiment of the invention, the scheduling module 206 is linked to the hold database 209. By accessing the hold database 209, the scheduling module 206 can determine the hold date(s) until which each insurance carrier desires to delay output of certain system-generated hold reports. For example, on the hold date(s), the scheduling module 206 can signal the reporting module 207 to output each report. In addition, depending on the rule data, the scheduling module 206 can signal the reporting module to update the contents of each hold report and/or verify the contents of each hold report on or before the hold date.

When signaled by the scheduling module 206 to generate a report, the reporting module 207 submits certain policy data, insured data, and rule data to the coverage verification module 135 for report generation. The coverage verification module 135 is operable to generate coverage verification reports. A coverage verification report is a report based on the insurance coverage of one or more youthful drivers. For example the coverage verification report can comprise information regarding whether a youthful driver residing with a person insured by a particular insurance carrier is himself a customer of the insurance carrier.

Upon report generation, the reporting module 207 can output the report and/or store the report in a report database 227.

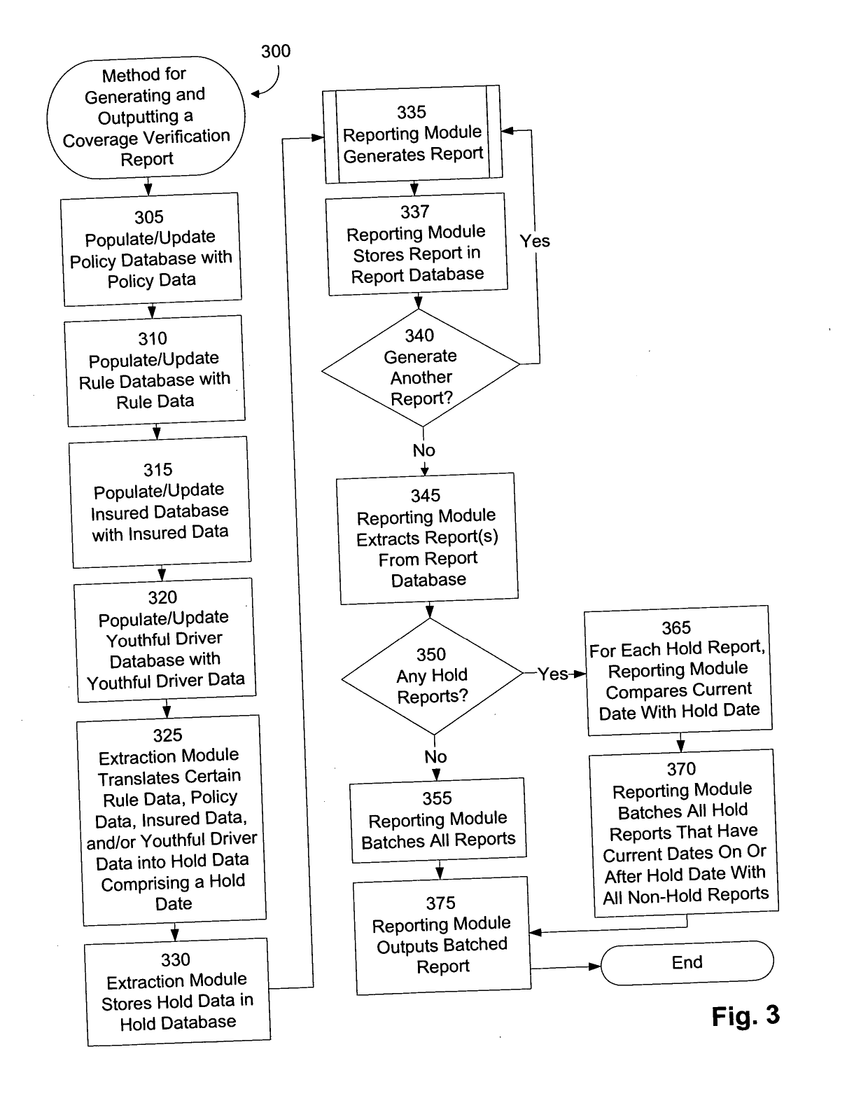

FIG. 3 is a flow chart depicting a method 300 for generating and outputting at appropriate times customized coverage verification reports, according to an exemplary embodiment of the invention. The exemplary method 300 is illustrative and, in alternative embodiments of the invention, certain steps can be performed in a different order, in parallel with one another, or omitted entirely, and/or certain additional steps can be performed without departing from the scope and spirit of the invention. The method 300 is described below with reference to FIGS. 1-3.

In step 305, the policy database 110 is populated and/or updated with policy data. For example, at least one insurance carrier and/or an agent or agents of the insurance carrier(s) can populate and/or update the policy database 110 via a terminal 155 or an alternative data transfer means known in the art.

In step 310, the rule database 208 is populated and/or updated with rule data. For example, agent(s) of the insurance carrier(s) can populate and/or update the rule database 208 via a terminal 155 or an alternative data transfer means known in the art.

In step 315, the insured database 120 is populated and/or updated with insured data. For example, the insurance carrier(s) and/or agent(s) can populate and/or update the insured database 120 via a terminal 155 or an alternative data transfer means known in the art.

In step 320, the youthful driver database 140 is populated and/or updated with youthful driver data. For example, the agent(s) can populate and/or update the youthful driver database 140 via a terminal 155 or an alternative data transfer means known in the art.

In step 325, the extraction module 115 translates certain of the rule data, policy data, insured data, and/or youthful driver data into hold data comprising a hold date. The hold date is a date until which the system 100 will delay outputting a particular generated report. For example, the hold date can be based on one or more pre-designated preferences of the insurance carrier. In certain embodiments of the invention, in accordance with the rule data, no hold date will exist. In step 330, the extraction module 115 stores the hold data, if any, in the hold database 209.

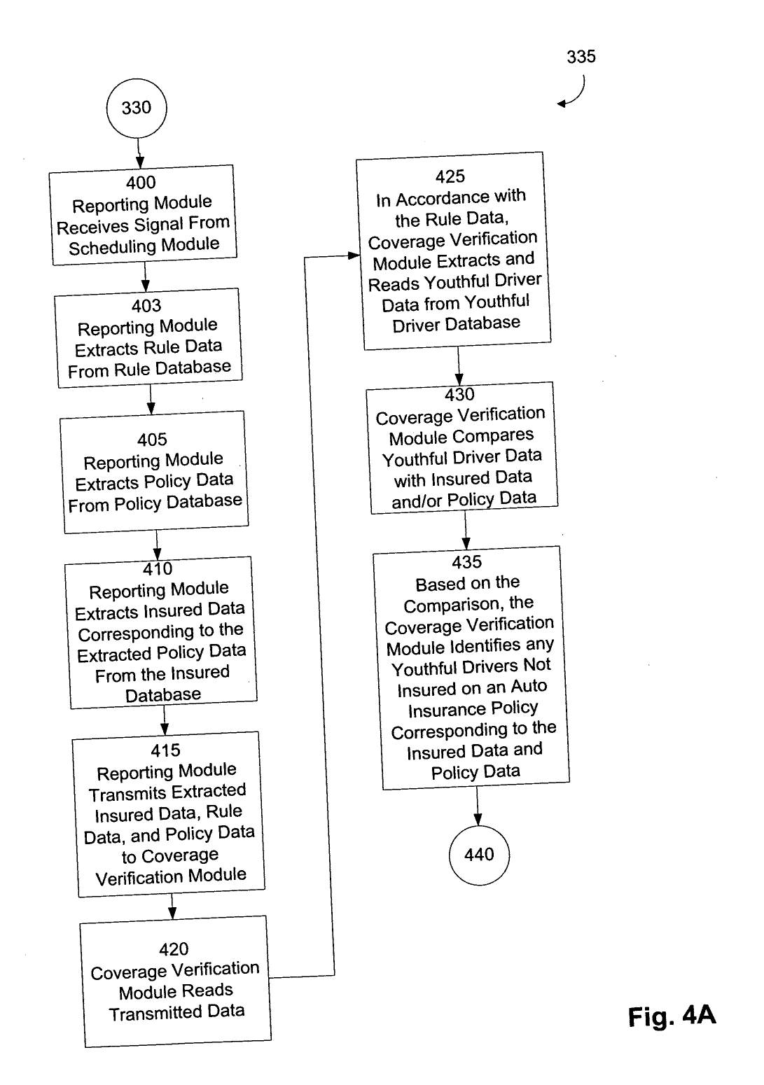

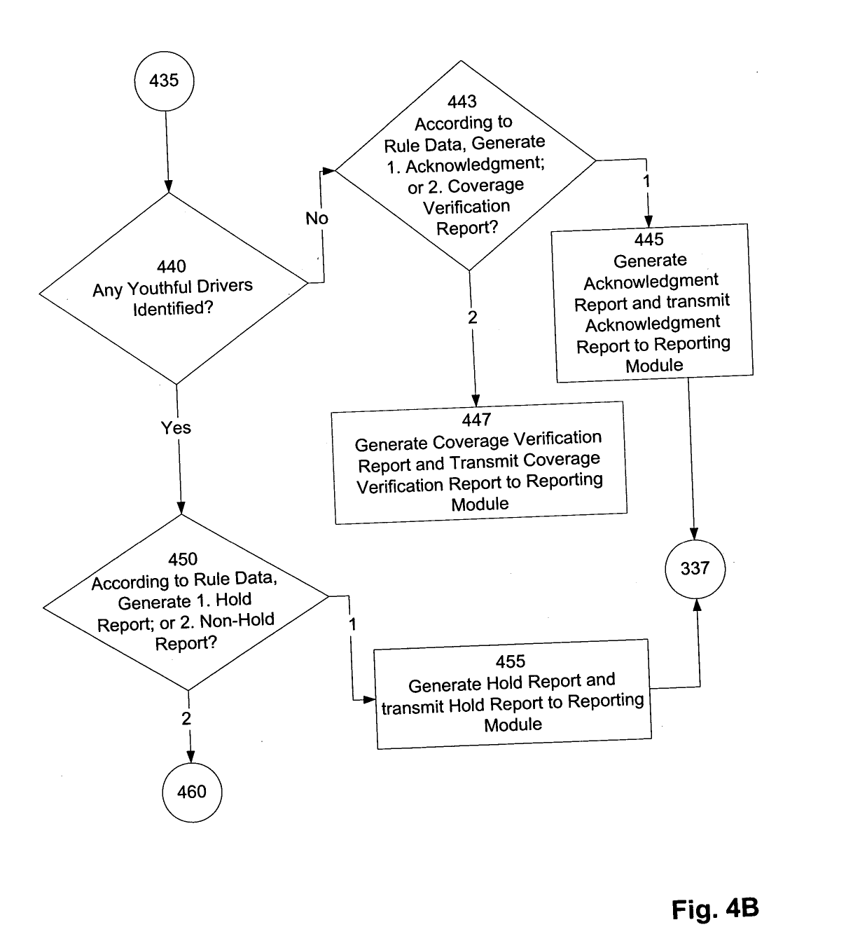

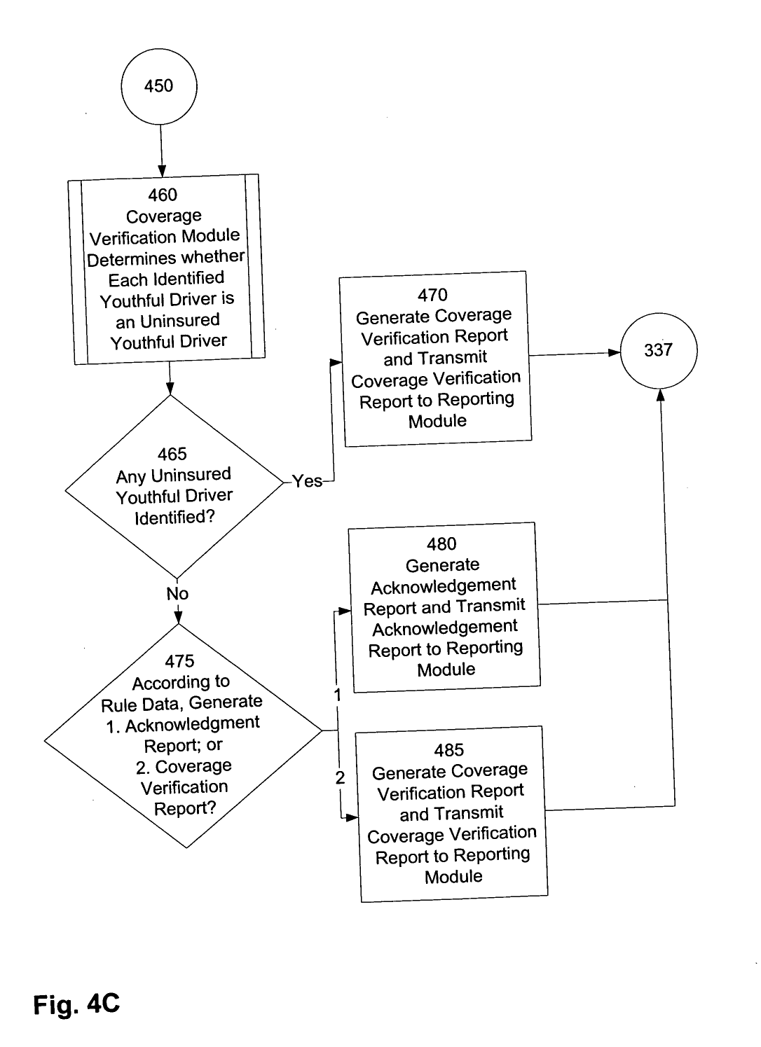

In step 335, the reporting module 207 generates a report. For example, the report can be a coverage verification report. Step 335 is discussed in more detail below with reference to FIG. 4. The reporting module 207 stores the generated report in the report database 227 in step 337.

In step 340, the reporting module 207 determines whether to generate another report. If so, the method 300 branches back to step 335 to repeat the generation and storage of another report. If the reporting module 207 will not generate another report, then the method 300 branches to step 345.

In step 345, the reporting module 207 extracts certain of the generated report(s) from the report database 227. For example, the reporting module 207 can extract non-acknowledgment reports from the report database 227. As described below with reference to step 443 of FIG. 4, an acknowledgment report is a report for internal system purposes only. An acknowledgment report will not be outputted to a report recipient.

In step 350, the reporting module 207 determines whether each extracted report is a hold report. If the reporting module 207 determines that any extracted report is a hold report, the method 300 branches to step 365. In step 365, the reporting module 207 compares the then-current date with the hold date corresponding to each hold report. For example, the reporting module 207 can determine the hold date corresponding to each hold report by accessing the hold database 209. Alternatively, if the hold report itself comprises the hold date, the reporting module 207 simply can refer to the hold report to determine the hold date.

If the then-current date is before the hold date, the reporting module 207 takes no further action with regard to the hold report; the hold report remains stored in the report database 227. If the then-current date is on or after the hold date, the reporting module 207 will output the hold report. For example, the reporting module 207 can immediately output each such hold report. Alternatively, prior to outputting the report(s), the reporting module 207 can batch the report(s) together.

For example, as illustrated in step 370, the reporting module 207 can batch the report(s) together with all of the extracted non-hold reports, if any. As used herein, the term “batch” refers to grouping and/or combining together one or more reports. For example, batching can comprise combining verbatim copies of each report into one “master” report. Alternatively, batching can comprise parsing and combining portions of each report to create a single, comprehensive report. The rule data determines the format and content of the batched report.

In step 375, the reporting module 207 outputs the batched report. The term “output” is used herein to refer to any form of display or transmission. For example, the reporting module 207 can output the report by communicating a digital copy of the report to a display or a data storage device of a terminal 155. In one embodiment of the invention, the reporting module 207 can communicate an email message comprising the report to a report recipient. Alternatively, the reporting module 207 can output the report by printing the report onto paper.

If the reporting module 207 determines in step 350 that each report extracted in step 345 is not a hold report, then the method branches to step 355. In step 355, the reporting module batches the extracted report(s) into a batched report. Then, the method 300 branches to step 375 discussed above.

FIG. 4 is a flow chart depicting a method 335 for generating a coverage verification report, according to an exemplary embodiment of the invention, as referred to in step 335 of FIG. 3. The exemplary method 335 is merely illustrative and, in alternative embodiments of the invention, certain steps can be performed in a different order, performed in parallel with one another, or omitted entirely, and/or certain additional steps can be performed without departing from the scope and spirit of the invention. The method 335 is described below with reference to FIGS. 1, 2, and 4.

In step 400, the reporting module 207 receives a signal from the scheduling module 206. The signal comprises instructions to the reporting module 207 to generate a report for a report recipient. For example, the report recipient can be an insurance carrier and/or an agent of the insurance carrier.

In step 403, the reporting module 207 extracts rule data from the rule database 208. The rule data comprises information regarding the report recipient's preferences, and internal rules, for the generation and output of the report. By accessing the rule data, the reporting module 207 can ensure that, in generating and outputting the report, it follows appropriate system protocol and generates and outputs the report in compliance with the report recipient's designated preferences.

For example, the rule data can comprise the report recipient's preference to base the report on the insurance coverage of youthful drivers residing in New York with other persons who already are auto insurance customers of a particular insurance carrier. From that designated preference, the reporting module 207 will know to generate the report using data related to the particular insurance carrier's auto insurance policies and insured persons residing in New York.

In accordance with the rule data, the reporting module 207 extracts certain of an insurance carrier's policy data from the policy database 110 in step 405. For example, where the rule data comprises the report recipient's preference to base the report on the insurance coverage of youthful drivers residing in New York with other persons who already are auto insurance customers of a particular insurance carrier, the reporting module 207 can extract all of the particular insurance carrier's auto insurance policy data.

The extracted policy data comprises information regarding at least one auto insurance policy. In particular, the policy data comprises information identifying the person(s) insured on each auto insurance policy. For example, the policy data can comprise a PIN number corresponding to insured data related to the insured person(s).

In step 410, in accordance with the rule data, the reporting module 207 extracts insured data from the insured database 120. The insured data corresponds to the policy data extracted in step 405. The insured data comprises information regarding the insured person(s) covered on the insurance policy(ies) about which the extracted policy data relates.

As set forth above, where the rule data comprises the report recipient's preference to base the report on the insurance coverage of youthful drivers residing in New York with other persons who already are auto insurance customers of a particular insurance carrier, the reporting module 207 can extract all of the particular insurance carrier's auto insurance policy data in step 405. In step 410, the reporting module can extract insured data corresponding to each insured person living in New York who is insured on an auto insurance policy of the particular insurance carrier.

In one embodiment of the invention, the reporting module 207 can generate a report without extracting policy data. For example, if the report will not comprise policy data and if the rule data designates a particular insured person about whom to generate a report, the reporting module 207 can generate the report without extracting both policy data and insured data.

In step 415, the reporting module 207 transmits the extracted insured data, rule data, and policy data to the coverage verification module 135 for report generation.

The coverage verification module 135 reads the transmitted data in step 420. In accordance with the rule data, the coverage verification module 135 extracts and reads youthful driver data from the youthful driver database 140 in step 425.

For example, following the example set forth above, if the rule data indicates the report recipient's preference to base the report on the insurance coverage of youthful drivers residing in New York with other persons who already are auto insurance customers of a particular insurance carrier, the coverage verification module 135 can extract and read youthful driver data corresponding to each youthful driver residing with an insured person about whom the insured data relates. For example, to extract and read the correct youthful driver data, the coverage verification module 135 can compare the address of each youthful driver to the address of each insured person. If the addresses match, the coverage verification module 135 can extract and read the youthful driver data.

In addition, in accordance with the rule data, the coverage verification module 135 can limit its extraction and reading of youthful driver data based on characteristics of the youthful drivers and/or the insured persons residing with the youthful drivers. For example, if the rule data indicates a preference to provide information only about youthful drivers residing with insured persons in a certain age group, the coverage verification module 135 can extract and read only youthful driver data regarding youthful drivers residing with insured persons in the age group. As another example, depending on the rule data, the coverage verification module 135 can limit extraction and reading only to youthful driver data regarding youthful drivers with full licenses (not permit licenses) granted during a certain time period.

In step 430, the coverage verification module 135 compares the youthful driver data extracted in step 425 with the insured data and/or policy data read in step 420. The comparison determines whether each youthful driver about whom the youthful driver data corresponds is covered by an auto insurance policy corresponding to the policy data and insured data. For example, the coverage verification module 135 can compare the name, date of birth, and/or driver's license number of each youthful driver to the insured data and/or the policy data to determine whether each youthful driver is covered by an auto insurance policy corresponding to the policy data and insured data.

In step 435, the coverage verification module 135 identifies any youthful drivers who are not covered by an auto insurance policy corresponding to the policy data and insured data. In step 440, the coverage verification module 135 determines whether it identified any such youthful drivers. If not, the method 335 branches to step 443.

In step 443, the coverage verification module 135 determines whether, according to the rule data, it will generate an acknowledgment report or a coverage verification report. An acknowledgment report is a report comprising an acknowledgment that the coverage verification module 135 failed to obtain any pertinent information. For example, the coverage verification module 135 can generate an acknowledgment report when the rule data indicates a preference of the report recipient not to receive a report unless pertinent information (i.e., information identifying at least one identified youthful driver not covered by an auto insurance policy corresponding to the policy data and insured data) is obtained. Because the acknowledgment report is a record of non-report-outputting work performed by the coverage verification module 135, the acknowledgment report can serve as a record by which the performance of the coverage verification module 135 can be monitored.

If the coverage verification module 135 determines in step 443 to generate an acknowledgment report, the method 335 branches to step 445. In step 445, the coverage verification module 135 generates the acknowledgment report and transmits the acknowledgment report to the reporting module 207. The rule data dictates the format and content of the acknowledgment report. For example, the acknowledgment report can comprise rule data, policy data, insured data, and/or youthful driver data. Upon completion of step 445, the method 335 branches to step 337 (FIG. 3).

If the coverage verification module 135 determines in step 443 to generate a coverage verification report, the method 335 branches to step 447. In step 447, the coverage verification module 135 generates the coverage verification report and transmits the coverage verification report to the reporting module 207. For example, the coverage verification report can inform the report recipient that the coverage verification module 135 failed to obtain any pertinent information. The rule data dictates the format and content of the coverage verification report. For example, the coverage verification report can comprise rule data, policy data, insured data, and/or youthful driver data. Upon completion of step 447, the method 335 branches to step 337 (FIG. 3).

If the coverage verification module 135 determines in step 440 that it identified at least one youthful driver who is not covered by an auto insurance policy corresponding to the policy data and the insured data, the method 335 branches to step 450.

In step 450, the coverage verification module 135 determines whether, according to the rule data, it will generate a hold report or a non-hold report. For example, the rule data can indicate that, upon identification of a youthful driver who is not covered by an auto insurance policy corresponding to the policy data and insured data, the coverage verification module 135 should immediately generate a (non-hold) report and output the report to the report recipient. Alternatively, the rule data can indicate a preference to generate a (hold) report and hold the report until a later hold date. For example, the report recipient may wish to receive the information in the hold report at a later, more desirable time.

At or before the hold date, the information in the hold report can be verified and/or updated based on then-current information. For example, on or before the hold date, the reporting module 207 and coverage verification module 135 can determine whether each identified youthful driver about which the hold report is based is an uninsured youthful driver. Waiting until a later hold date to output the results of such a determination allows each identified youthful driver a grace period during which to obtain his or her own insurance coverage. Until at least the hold date, no report regarding the youthful driver(s) will be outputted. Thus, until at least the hold date, the youthful driver(s) will be free to obtain insurance coverage without solicitation. In addition, until at least the hold date, the insurance premium(s) of any existing customer(s) living with the youthful driver(s) will not be raised.

If the coverage verification module 135 determines in step 450 to generate a hold report, the method 335 branches to step 455. In step 455, the coverage verification module 135 generates the hold report. The rule data dictates the format and content of the hold report. For example, the hold report can comprise rule data, policy data, insured data, and/or youthful driver data. Upon generation of the report, the method 335 branches to step 337 (FIG. 3).

If the coverage verification module 135 determines in step 450 to generate a non-hold report, the method 335 branches to step 460. In step 460, the coverage verification module 135 determines whether each youthful driver identified in step 435 is an uninsured youthful driver. The coverage verification module 135 makes such a determination by determining whether each youthful driver identified in step 435 is insured on an auto insurance policy other than the policy or policies corresponding to the insured data and policy data read in step 420.

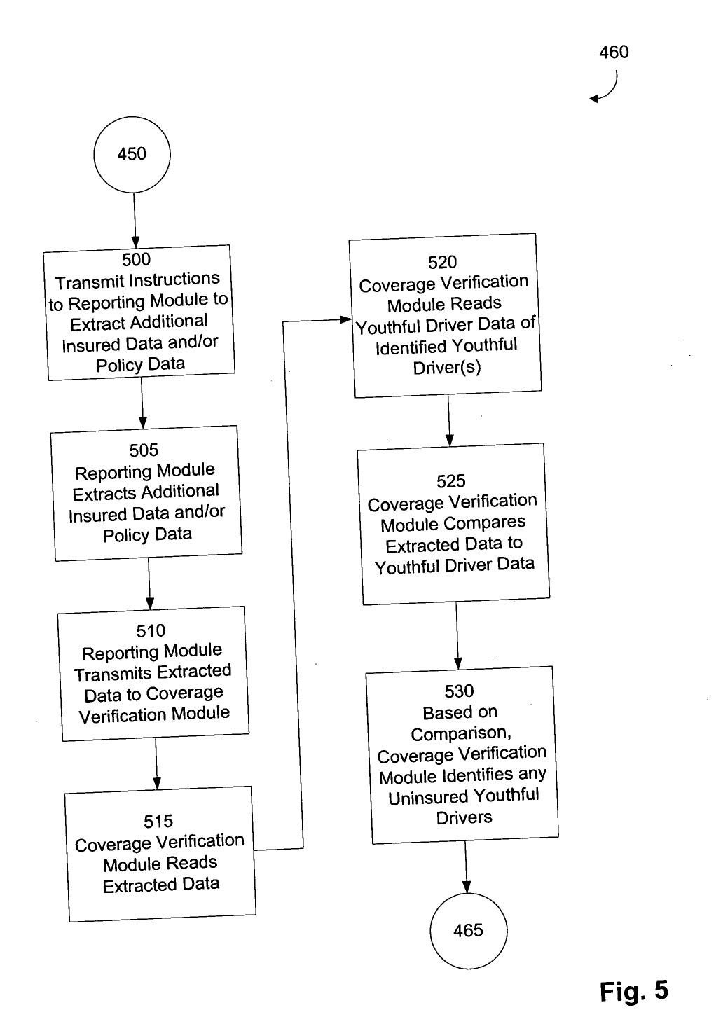

For example, the coverage verification module 135 can determine whether each identified youthful driver is insured on another policy with the particular insurance carrier about which the insured data and/or policy data corresponds. In addition, the coverage verification module 135 can determine whether each identified youthful driver is insured on another policy with another insurance carrier. Step 460 is described in more detail below with reference to FIG. 5.

In step 465, the coverage verification module 135 determines whether it identified any uninsured youthful drivers. In other words, the coverage verification module 135 determines whether any of the youthful drivers identified in step 435 are not insured on another insurance policy. If the coverage verification module 135 determines in step 465 that at least one of the youthful drivers identified in step 435 is an uninsured youthful driver, the method 335 branches to step 470.

In step 470, the coverage verification module 135 generates a coverage verification report and transmits the coverage verification report to the reporting module 207. The rule data dictates the format and content of the coverage verification report. For example, the coverage verification report can comprise rule data, policy data, insured data, and/or youthful driver data. Upon generation of the report, the method 335 branches to step 337 (FIG. 3).

In one embodiment of the invention, in accordance with the rule data, the generated coverage verification report can be a hold report.

If the coverage verification module 135 determines in step 465 that it failed to identify any uninsured youthful drivers, the method branches to step 475. In step 475, the coverage verification module 135 determines whether, according to the rule data, it will generate an acknowledgment report or a coverage verification report. Because each youthful driver identified in step 435 already has auto insurance, the report recipient may wish to forego receiving a report. Accordingly, the rule data can indicate a preference to generate an acknowledgment, rather than a coverage verification, report. Alternatively, the rule data can indicate a preference to generate a coverage verification report comprising an indication that the coverage verification module 135 failed to identify any uninsured youthful drivers.

If the coverage verification module 135 determines in step 475 to generate an acknowledgment report, the method 335 branches to step 480. In step 480, the coverage verification module 135 generates an acknowledgment report and transmits the acknowledgment report to the reporting module 207. The rule data dictates the format and content of the acknowledgment report. For example, the acknowledgment report can comprise rule data, policy data, insured data, and/or youthful driver data. Upon generation of the report, the method 335 branches to step 337 (FIG. 3).

If the coverage verification module 135 determines in step 475 to generate a coverage verification report, the method 335 branches to step 485. In step 485, the coverage verification module 135 generates the coverage verification report and transmits the coverage verification report to the reporting module 207. For example, the coverage verification report can inform the report recipient that each identified youthful driver already has auto insurance and/or that the coverage verification module 135 failed to identify any uninsured youthful drivers.

The rule data dictates the format and content of the coverage verification report. For example, the coverage verification report can comprise rule data, policy data, insured data, and/or youthful driver data. Upon completion of step 485, the method 335 branches to step 337 (FIG. 3).

FIG. 5 is a flow chart depicting a method 460 for determining whether each youthful driver identified in step 435 is an uninsured youthful driver, according to an exemplary embodiment of the invention, as referred to in step 460 of FIG. 4. The exemplary method 460 is merely illustrative and, in alternative embodiments of the invention, certain steps can be performed in a different order, performed in parallel with one another, or omitted entirely, and/or certain additional steps can be performed without departing from the scope and spirit of the invention. The method 460 is described below with reference to FIGS. 1, 2, 4, and 5.

In step 500, the coverage verification module 135 transmits instructions to the reporting module 207 to extract additional insured data and/or policy data. The additional insured data and/or policy data can relate to additional insured persons and/or insurance policies of the particular insurance carrier about which the insured data and/or policy data read in step 420 corresponds. In addition, the additional insured data and/or policy data can relate to insured persons and/or insurance policies of another insurance carrier or carriers. For example, the coverage verification module 135 can instruct the reporting module 207 to extract all (auto insurance-related) policy data and all insured data in the policy database 110 and the insured database 120, respectively.

In step 505, the reporting module 207 follows the instructions of the coverage verification module 135 to extract the additional insured data and/or policy data. In step 510, the reporting module 207 transmits the additional insured data and/or policy data extracted in step 505 to the coverage verification module 135. In step 515, the coverage verification module 135 reads the additional insured data and/or policy data transmitted in step 510.

In step 520, the coverage verification module 135 reads the youthful driver data corresponding to the youthful drivers identified in step 435 (FIG. 4). In step 525, the coverage verification module 135 compares the additional insured data and/or policy data read in step 515 to the youthful driver data read in step 520. The comparison determines whether each youthful driver about whom the youthful driver data corresponds is an uninsured driver. In other words, the comparison determines whether each youthful driver is covered on an auto insurance policy provided by the particular insurance carrier(s) about which the additional policy data and/or insured data corresponds.

For example, the coverage verification module 135 can compare the name, date of birth, and/or driver's license number of each youthful driver to the additional insured data and/or policy data to determine if each youthful driver is insured on an auto insurance policy of any particular insurance carrier.

In step 530, the coverage verification module 135 identifies any uninsured youthful drivers. In other words, the coverage verification module 135 identifies any youthful drivers who are not insured on any particular insurance carrier's auto insurance policy. Then, the method 460 branches to step 465.

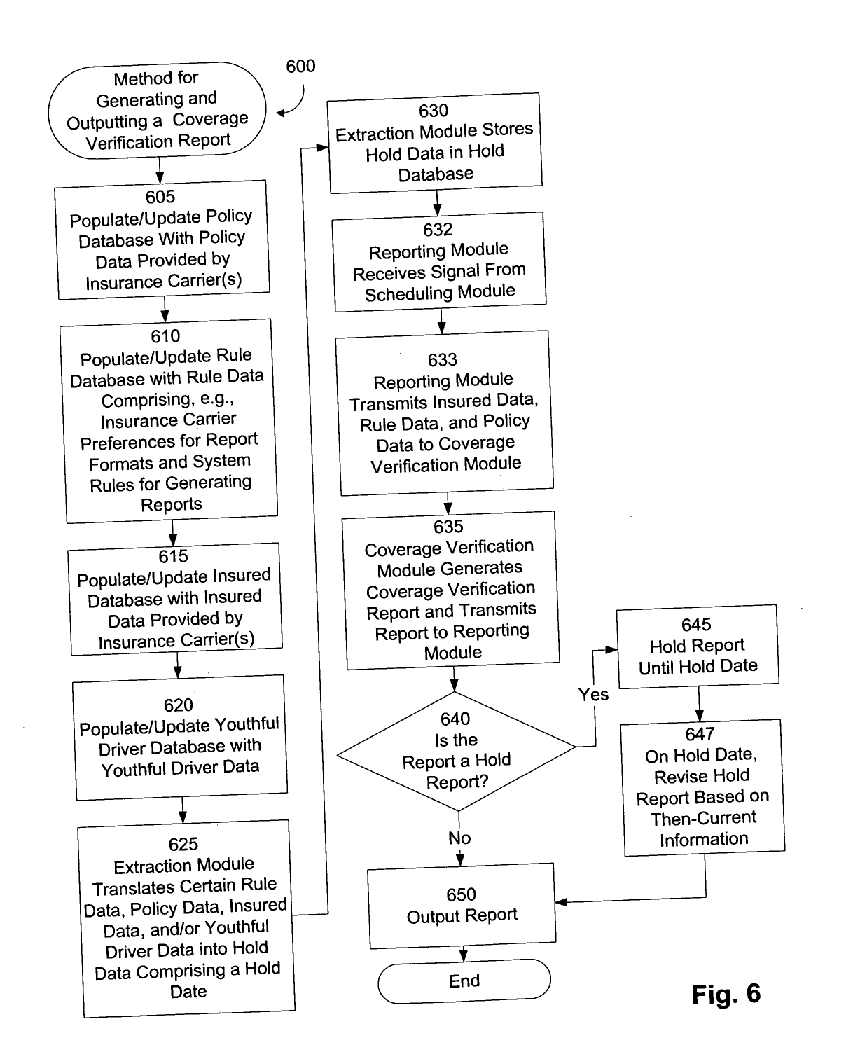

FIG. 6 is a flow chart depicting a method 600 for generating and outputting at appropriate times customized coverage verification reports, according to an exemplary embodiment of the invention. The exemplary method 600 is merely illustrative and, in alternative embodiments of the invention, certain steps can be performed in a different order, performed in parallel with one another, or omitted entirely, and/or certain additional steps can be performed without departing from the scope and spirit of the invention. The method 600 is described below with reference to FIGS. 1, 2, and 6.

In step 605, the policy database 110 is populated and/or updated with policy data. For example, at least one insurance carrier and/or an agent or agents of the insurance carrier(s) can populate and/or update the policy database 110 via a terminal 155 or an alternative data transfer means known in the art.

In step 610, the rule database 208 is populated and/or updated with rule data. For example, the agent(s) can populate and/or update the rule database 208 via a terminal 155 or an alternative data transfer means known in the art.

In step 615, the insured database 120 is populated and/or updated with insured data. For example, the insurance carrier(s) and/or agent(s) can populate and/or update the insured database 120 via a terminal 155 or an alternative data transfer means known in the art.

In step 620, the youthful driver database 140 is populated and/or updated with youthful driver data. For example, the agent(s) can populate and/or update the youthful driver database 140 via a terminal 155 or an alternative data transfer means known in the art. In one embodiment of the invention, the coverage verification module 135 can populate and/or update the youthful driver database 140.

In step 625, the extraction module 115 translates certain of the rule data, policy data, insured data, and/or youthful driver data into hold data comprising a hold date. The hold date is a date until which the system 100 will delay outputting a particular generated report. For example, the hold date can be based on one or more pre-designated preferences of the insurance carrier. In certain embodiments of the invention, no hold date will exist. In step 630, the extraction module 115 stores the hold data, if any, in the hold database 209.

In step 632, the reporting module 207 receives a signal from the scheduling module 206. The signal comprises instructions to the reporting module 207 to generate a report for a report recipient. For example, the report recipient can be an insurance carrier and/or an agent of the insurance carrier.

In step 633, the reporting module 207 transmits appropriate rule data, policy data, and insured data to the coverage verification module 135 for report generation. For example, the reporting module 207 can proceed in accordance with steps 403-415 of FIG. 4 to transmit the appropriate rule data, policy data, and insured data to the coverage verification module 135.

Utilizing the data transmitted in step 633, the coverage verification module 135 generates a coverage verification report and transmits the generated report to the reporting module 207 in step 635. For example, the coverage verification module 135 can proceed in accordance with steps 420-485 of FIG. 4 to generate the coverage verification report and transmit the generated report to the reporting module 207.

In step 640, the reporting module 207 determines whether the generated report is a hold report. If not, the method 600 branches to step 650. In step 650, the reporting module 207 immediately outputs the generated report.

If the reporting module 207 determines in step 640 that the generated report is a hold report, the method 600 branches to step 645. In step 645, the reporting module 207 holds the generated report until the report's hold date. For example, the reporting module 207 can determine the hold date corresponding to the hold report by accessing the hold database 209. Alternatively, if the hold report itself comprises the hold date, the reporting module 207 simply can refer to the hold report to determine the hold date.

In step 647, the reporting module 207 revises the hold report on the hold date, based on then-current information. For example, the reporting module 207 can instruct the coverage verification module 135 to re-generate the report based on then-current information. To re-generate the report, the reporting module 207 can resubmit appropriate rule data, policy data, and insured data to the coverage verification module 135 for report generation. For example, the reporting module 207 can proceed in accordance with steps 403-415 of FIG. 4 to transmit the appropriate rule data, policy data, and insured data to the coverage verification module 135. Utilizing the transmitted data, the coverage verification module 135 can generate a coverage verification report and transmit the generated report to the reporting module 207. For example, the coverage verification module 135 can proceed in accordance with steps 420-485 of FIG. 4 to generate the coverage verification report and transmit the generated report to the reporting module 207.

Rather than instructing the coverage verification module 135 to re-generate the report, the reporting module 207 can work with the coverage verification module 135 to verify the contents of the report and/or to update the contents of the report. For example, if the hold report indicates that a particular youthful driver is not insured on specific policies of a particular insurance carrier, the reporting module 207 can transmit updated policy data and/or insured data regarding the specific policies of the insurance carrier to the coverage verification module 135. The coverage verification module 135 can compare the transmitted data to youthful driver data regarding the particular youthful driver to determine whether, on the hold date, the youthful driver is still not insured on any of the specific policies.

In addition, the reporting module 207 can work with the coverage verification module 135 to determine whether the particular youthful driver is an uninsured youthful driver. For example, the reporting module 207 and coverage verification module 135 can proceed in accordance with steps 505-530 of FIG. 5 to determine whether the youthful driver is an uninsured youthful driver.

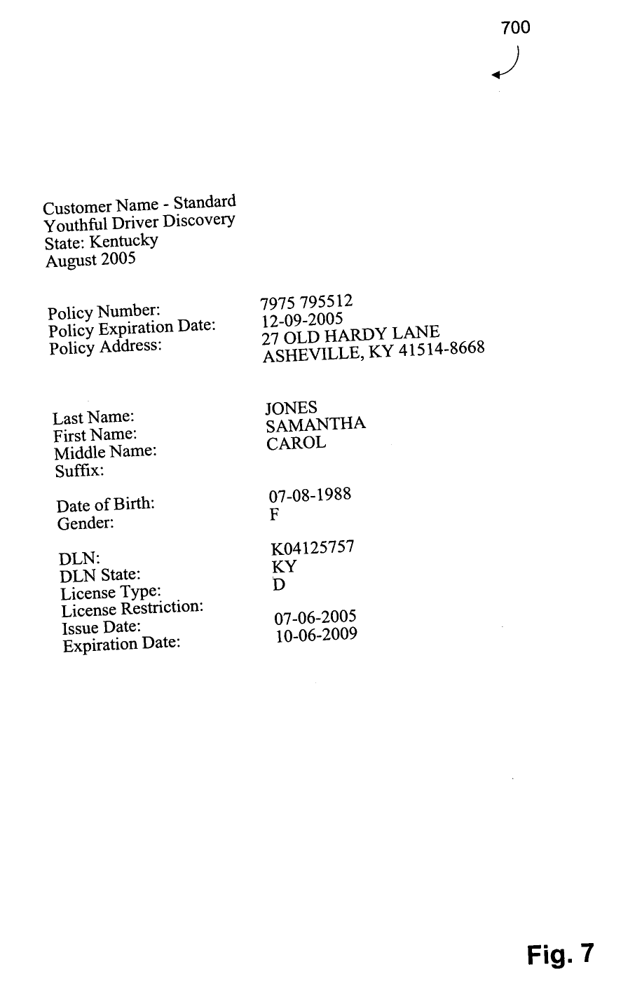

FIG. 7 is a block diagram depicting a coverage verification report 700 generated in accordance with an exemplary embodiment of the invention. The report 700 is merely illustrative and, in alternative embodiments of the invention, certain elements of the report 700 can be altered; certain elements can be omitted entirely; and/or certain additional elements can be included.

The report 700 comprises information regarding an identified youthful driver. The youthful driver's name is Samantha Carol Jones. She was born on Jul. 8, 1988 and is licensed to drive in Kentucky. Her driver's license was issued on Jul. 6, 2005 and will expire on Oct. 6, 2009. She resides at 27 Old Hardy Lane Asheville, Ky. 41514-8668 with an existing auto insurance customer of a particular insurance carrier. The existing auto insurance customer's insurance policy number is 7975 795512. The policy is due to expire on Dec. 9, 2005.

Based on the information in the report 700, the insurance carrier may be able to raise the existing customer's insurance premium. The higher premium can account for the insurance carrier's coverage of Samantha Carol Jones.

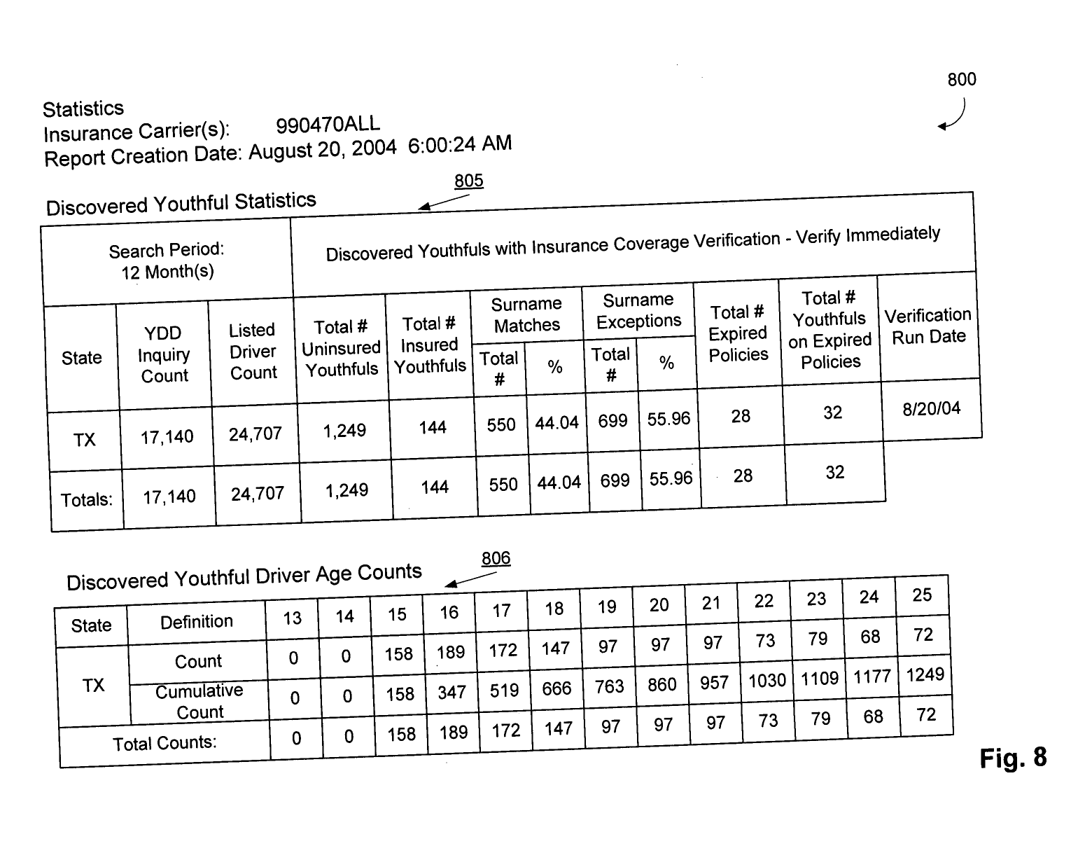

FIG. 8 is a block diagram depicting a coverage verification report 800 generated in accordance with an alternative exemplary embodiment of the invention. The report 800 is merely illustrative and, in alternative embodiments of the invention, certain elements of the report 800 can be altered; certain elements can be omitted entirely; and/or certain additional elements can be included.

The report 800 comprises a discovered youthful driver statistics table 805 and a discovered youthful driver age counts table 806. The discovered youthful driver statistics table 805 comprises information regarding identified youthful drivers who reside in Texas with existing customers of insurance carrier(s) 990470ALL. In the state of Texas, there are 1,249 uninsured youthful drivers and 144 insured youthful drivers residing with existing auto insurance customers of insurance carrier(s) 990470ALL.

Of the 1,249 uninsured youthful drivers, 550 (or 44.04%) of them have the same surname as the existing customer, and 699 (or 55.96%) of them have a different surname as the existing customer. 28 of the existing customers have expired insurance policies. 32 of the uninsured youthful drivers reside with existing customers who have expired insurance policies.

The discovered youthful driver age counts table 806 comprises information regarding the ages of the 1,249 identified uninsured youthful drivers. 158 of the uninsured youthful drivers are age 15; 189 of the uninsured youthful drivers are age 16; 172 of the uninsured youthful drivers are age 17; 147 of the uninsured youthful drivers are age 18; 97 of the uninsured youthful drivers are age 19; 97 of the uninsured youthful drivers are age 20; 97 of the uninsured youthful drivers are age 21; 73 of the uninsured youthful drivers are age 22; 79 of the uninsured youthful drivers are age 23; 68 of the uninsured youthful drivers are age 27; and 72 of the uninsured youthful drivers are age 25.

The present invention can be used with computer hardware and software that performs the methods and processing functions described above. As will be appreciated by a person of skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

We claim:

1. A computer-implemented method for determining whether a youthful driver is an uninsured youthful driver, comprising the steps of:
creating policy data for each of a plurality of insurance carriers, the policy data comprising information regarding at least one auto insurance policy of each respective insurance carrier, the plurality of insurance carriers comprising a first insurance carrier and at least one other insurance carrier;
for each auto insurance policy, creating insured data comprising information regarding at least one insured person insured on the auto insurance policy;
creating youthful driver data comprising information regarding the youthful driver;
determining whether the youthful driver is insured on an auto insurance policy of the first insurance carrier by comparing the youthful driver data to at least one of the policy data and the insured data corresponding to the first insurance carrier; and
determining whether the youthful driver is insured on an auto insurance policy of any of the plurality of insurance carriers by comparing the youthful driver data to at least one of the policy data and the insured data corresponding to the plurality of insurance carriers, in response to a determination that the youthful driver is not insured on an auto insurance policy of the first insurance carrier.

2. The computer-implemented method of claim 1, wherein the youthful driver resides with an insured person insured on an auto insurance policy of one of the plurality of insurance carriers.

3. The computer-implemented method of claim 1, wherein the youthful driver resides with an insured person insured on an auto insurance policy of the first insurance carrier.

4. The computer-implemented method of claim 1, wherein the step of determining whether the youthful driver is insured on an auto insurance policy of the first insurance carrier further comprises comparing the youthful driver data to at least one of the policy data and the insured data corresponding to the first insurance carrier on a first day, and the step of determining whether the youthful driver is insured on an auto insurance policy of any of the plurality of insurance carriers further comprises comparing the youthful driver data to at least one of the policy data and the insured data corresponding to the plurality of insurance carriers on a second day.

5. The computer-implemented method of claim 1, wherein the youthful driver data comprises at least one of a name of the youthful driver, an address of the youthful driver, a driver's license issue date of the youthful driver, and a date of birth of the youthful driver.

6. The computer-implemented method of claim 1, further comprising the step of generating a report comprising information regarding whether the youthful driver is insured on an auto insurance policy of the first insurance carrier.

7. The computer-implemented method of claim 6, further comprising the step of creating rule data designating at least one of the format of the report and the content of the report, wherein the step of generating the report comprises applying the rule data to at least one of the policy data, insured data, and youthful driver data.

8. The computer-implemented method of claim 1, further comprising the step of generating a report comprising information regarding whether the youthful driver is insured on an auto insurance policy of any of the plurality of insurance carriers.

9. The computer-implemented method of claim 8, further comprising the step of creating rule data designating at least one of the format of the report and the content of the report, wherein the step of generating the report comprises applying the rule data to at least one of policy data, insured data, and youthful driver data.

10. A computer-implemented method for determining whether a youthful driver is an uninsured youthful driver, comprising the steps of:
creating policy data for each of a plurality of insurance carriers, the policy data comprising information regarding at least one auto insurance policy of each respective insurance carrier, the plurality of insurance carriers comprising a first insurance carrier and at least one other insurance carrier;
for each auto insurance policy, creating insured data comprising information regarding at least one insured person insured on the auto insurance policy;
identifying at least one youthful driver residing with an insured person;
determining whether each identified youthful driver is insured on an auto insurance policy of the first insurance carrier by comparing youthful driver data comprising information regarding the identified youthful driver to at least one of the policy data and the insured data corresponding to the first insurance carrier on a first day; and
determining whether the youthful driver is insured on an auto insurance policy of any of the plurality of insurance carriers by comparing the youthful driver data to at least one of the policy data and the insured data corresponding to the plurality of insurance carriers on a second day, in response to a determination that the youthful driver is not insured on an auto insurance policy of the first insurance carrier.

11. The computer-implemented method of claim 10, wherein the step of identifying at least one youthful driver residing with an insured person comprises identifying at least one youthful driver residing with an insured person insured on an auto insurance policy of the first insurance carrier.

12. The computer-implemented method of claim 10, wherein the youthful driver data comprises at least one of a name of the youthful driver, an address of the youthful driver, a driver's license issue date of the youthful driver, and a date of birth of the youthful driver.

13. The computer-implemented method of claim 10, further comprising the step of generating a report comprising information regarding whether each identified youthful driver is insured on an auto insurance policy of the first insurance carrier.

14. The computer-implemented method of claim 13, further comprising the step of creating rule data designating at least one of the format of the report and the content of the report, wherein the step of generating the report comprises applying the rule data to at least one of policy data, insured data, and youthful driver data.

15. The computer-implemented method of claim 10, further comprising the step of generating a report comprising information regarding whether each identified youthful driver is insured on an auto insurance policy of any of plurality of insurance carriers.

16. The computer-implemented method of claim 15, further comprising the step of creating rule data designating at least one of the format of the report and the content of the report, wherein the step of generating the report comprises applying the rule data to at least one of policy data, insured data, and youthful driver data.

17. A computer-implemented method for generating a report based on a youthful driver's insurance coverage, comprising the steps of:
creating policy data for each of a plurality of insurance carriers, the policy data comprising information regarding at least one auto insurance policy of each respective insurance carrier, the plurality of insurance carriers comprising a first insurance carrier and at least one other insurance carrier;
for each auto insurance policy, creating insured data comprising information regarding at least one insured person insured on the auto insurance policy;
creating youthful driver data comprising information regarding the youthful driver;
creating rule data comprising a formatting designation designating at least one of the format of the report and the content of the report, the formatting designation based on at least one of: (1) whether the youthful driver is insured on an auto insurance policy of the first insurance carrier, and (2) whether the youthful driver is insured on an auto insurance policy of any of the at least one other insurance carrier;
determining whether the youthful driver is insured on an auto insurance policy of the first insurance carrier by comparing the youthful driver data to at least one of the policy data and the insured data corresponding to the first insurance carrier;
determining whether the youthful driver is insured on an auto insurance policy of any of the plurality of insurance carriers by comparing the youthful driver data to at least one of the policy data and the insured data corresponding to the plurality of insurance carriers, in response to a determination that the youthful driver is not insured on an auto insurance policy of the first insurance carrier; and
generating a report in accordance with the rule data.

18. The computer-implemented method of claim 17, wherein the youthful driver resides with an insured person insured on an auto insurance policy of one of the plurality of insurance carriers.

19. The computer-implemented method of claim 17, wherein the youthful driver resides with an insured person insured on an auto insurance policy of the first insurance carrier.

20. The computer-implemented method of claim 17, wherein the step of determining whether the youthful driver is insured on an auto insurance policy of the first insurance carrier further comprises comparing the youthful driver data to at least one of the policy data and the insured data corresponding to the first insurance carrier on a first day, and the step of determining whether the youthful driver is insured on an auto insurance policy of any of the plurality of insurance carriers further comprises comparing the youthful driver data to at least one of the policy data and the insured data corresponding to the plurality of insurance carriers on a second day.

21. The computer-implemented method of claim 17, wherein the youthful driver data comprises at least one of a name of the youthful driver, an address of the youthful driver, a driver's license issue date of the youthful driver, and a date of birth of the youthful driver.
